(19) United States
(12) Patent Application Publication
(10) Pub. No.: US 2006/0021209 A1
(43) Pub. Date: Feb. 2, 2006

(54) Lift plate with positioning mechanism for adaptively aligning a workpiece

(76) Inventors: Michael W. Pfeiffer, Savage, MN (US); Brian D. Denker, Rogers, MN (US); Michael W. Elshof, Longmont, CO (US); Nathaniel P. Sheppleman, Longmont, CO (US); Michael T. Murray, Longmont, CO (US)

Correspondence Address: Seagate Technology LLC, 1280 Disc Drive, Shakopee, MN, 55379, US

(21) Appl. No.: 10/909,738

(22) Filed: Aug. 2, 2004

(51) Int. Cl. B23Q 3/00

(52) U.S. Cl. 29/464

(57) ABSTRACT

Method and apparatus for mating a base deck to an assembly nest are disclosed. The method incorporates use of an alignment post supported by a visco-elastic damping material and a cam controlled mechanical finger, each precluding exposure of excessive mechanical shock impacting a base deck during alignment and positioning of the base deck within an assembly nest. The method further incorporates use of a lift deck supported by a gimbal bearing mechanism. The gimbal bearing mechanism provides attitude compliance adjustment between a base deck datum surface, and a corresponding assembly nest datum surface. Attitude compliance adjustment is promoted by a gimbaling of the lift deck about a centralized spherical bearing of the gimbal bearing mechanism, which occurs subsequent to the alignment and positioning of the base deck in respective said first and second directions and during engagement of the base deck with the assembly nest.

### FIELD OF THE INVENTION

This invention relates generally to the field of assembly tooling and more particularly, but without limitation, to an apparatus that adaptively aligns to a workpiece, such as a head disc assembly, while laterally positioning the workpiece with a positioning mechanism within a predetermined range.

### BACKGROUND

Precise positioning of components and minimization of mechanical shock can be important considerations during device assembly operations. Head/disc interface reliability, and bearing integrity for spindle motors and actuators within data storage devices pose particularly distinct assembly handling and positioning issues.

Brinelled bearings, disc divots, and crazed sliders are among the types of damage that can occur during a data storage device assembly process, as a result of component mispositioning, or device mishandling. Device mishandling causing excessive mechanical shock and component mispositioning can result in an overstressing and damage of critical components, as well as causing damage to work stations or tooling within the work stations.

While various approaches for mechanical shock minimization during precise component positioning have been proposed, there nevertheless remains a continued need for improvements in the art, and it is to such improvements that the present invention is generally directed.

### SUMMARY OF THE INVENTION

In accordance with preferred embodiments, an apparatus and method are provided for mitigating mechanical shock imparted on a workpiece by impact forces of an alignment member in a mechanical finger of a lift plate used for precision positioning the workpiece within an assembly nest. The method generally comprises aligning the workpiece in a first direction relative to the lift plate using an alignment post supported by a visco-elastic damping material; using the mechanical finger to position the workpiece in the second direction relative to the lift plate; and adjusting an attitude of a lift deck supporting the visco-elastic damping material using a centralized spherical bearing mechanism communicating with the lift deck. Adjusting the attitude of the workpiece brings a surface of the workpiece into compliance with a datum of an assembly nest during an engagement of the workpiece with the assembly nest.

The apparatus generally comprises a lift deck supported by a centralized spherical bearing mechanism. The spherical bearing mechanism provides compliance adjustment for a surface of a workpiece relative to the lift deck during an interaction of the workpiece with the lift deck; and an alignment member attached to the lift deck, where the alignment member includes at least an alignment post supported by a visco-elastic damping material. The alignment post provides alignment of the workpiece in a first direction relative to the lift deck during the interaction of the workpiece with the lift deck.

These and various other features and advantages which characterize the claimed invention will be apparent from reading the following detailed description and a review of the associated drawings.

### BRIEF DESCRIPTION OF THE DRAWINGS

FIG. 1 is a top plan view of a data storage device provided in accordance with preferred embodiments of the present invention.

FIG. 2 provides an elevational view of the data storage device of FIG. 1 communicating with an assembly conveyor.

FIG. 3 is an exploded perspective view of a lift plate of the present invention.

FIG. 4 is a partial cut-away plan view of the data storage device of FIG. 1 in alignment with an assembly nest of present invention.

FIG. 5 is a cross-sectional view of the assembly nest of FIG. 4.

FIG. 6 is a partial cut-away elevational view of the data storage device of FIG. 1 supported by the lift plate of FIG. 3 while communicating with the assembly nest of FIG. 4.

FIG. 7 is partial cut-away elevational view of the data storage device of FIG. 1 supported by the assembly conveyor of FIG. 2 in relation to the lift plate of FIG. 3 prior to interaction of the lift plate with the data storage device.

FIG. 8 is a perspective view of a position of the lift plate of FIG. 3 prior to engagement with the data storage device of FIG. 1.

FIG. 9 is a perspective view of a position of the lift plate of FIG. 3 during the lift process when the lift plate is maintaining the data storage device of FIG. 1 in contact with the assembly nest of FIG. 4.

FIG. 10 is a partial cut-away prospective view of a gamble bearing of the lift plate of FIG. 3.

FIG. 11 is a flowchart of a process using the lift plate of FIG. 3.

### DETAILED DESCRIPTION

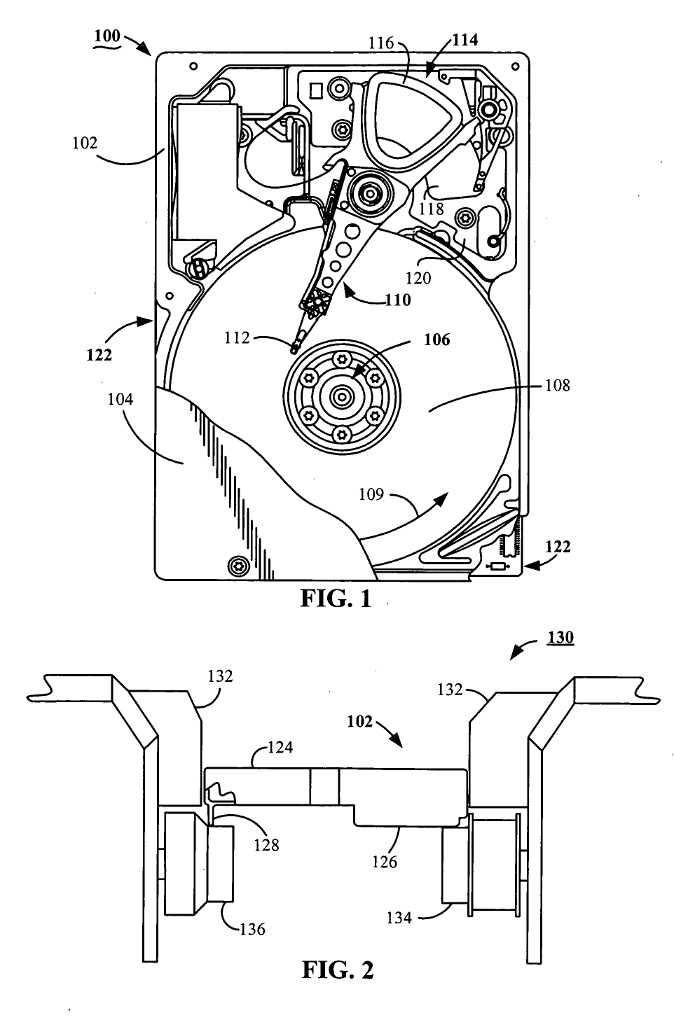

A data storage device (DSD), such as 100 shown in FIG. 1, provides a vehicle for discussing preferred embodiments of the present invention. In particular, a base deck 102 of the DSD 100 serves as a workpiece example for disclosure of an application for the present invention. The base deck 102 provides central support for the balance of the remaining components of the DSD 100.

A spindle motor 106 mounted within the base deck 102 rotates a number of rigid magnetic recording discs (discs) 108 in a rotational direction 109. An actuator 110 attached to the base deck supports a corresponding number of heads 112 adjacent tracks (not shown) defined on the disc surfaces. A voice coil motor (VCM) 114 supported by the base deck 102 is used to rotate the actuator 110 and hence, moves the heads 112 radially across the discs 108.

The VCM 114 includes a moveable actuator coil 116 and a stationary magnetic circuit. The magnetic circuit includes a permanent magnet 118 supported on a magnetically permeable pole piece 120, which is secured to the base deck 102. A second pole piece and a second permanent magnet are normally disposed over the coil to complete the magnetic circuit, but these components have been omitted in FIG. 1 to provide a better view of the actuator coil 116.

A top cover 104 (shown in partial cut-away) cooperates with the base deck 102 to form an environmentally controlled housing for the DSD 100, and a printed circuit board assembly (PCBA) 122, mounted to the underside of the base deck 102, provides control electronics for controlling operations of the DSD 100 and interface electronics for communicating with a host.

FIG. 2 shows that the base deck 102 includes a top surface 124, a bottom surface 126, and a mounting rail 128. The top surface 124 is a datum surface for the base deck 102, while the bottom surface 126 provides support for the PCBA 122 (of FIG. 1). The mounting rail 128 provides a means for attaching the DSD 100 (of FIG. 1) to the host.

Both the bottom surface 126 and the mounting rail 128 are cast surfaces, which are not particularly useful as reference surfaces for precision positioning of the base deck 102 during assembly of the DSD 100. However, because the top surface 124 is a datum surface for the base deck 102, the top surface 124 is useful for referencing the base deck 102 during the DSD 100 assembly process.

FIG. 2 further shows that a conveyor 130, found useful for DSD assembly lines, includes guide rails 132, drive wheels 134, and idler wheels 136. The guide rails 132 assist in maintaining the base deck 102 in course tolerance relative to the idler and drive wheels 136 and 134 respectively. The drive wheels 134 propel the base deck 102 into and out of workstations (not shown) along a DSD assembly line (not shown). The idler wheels support the base deck 102 during transport of the base deck 102 along the DSD assembly line.

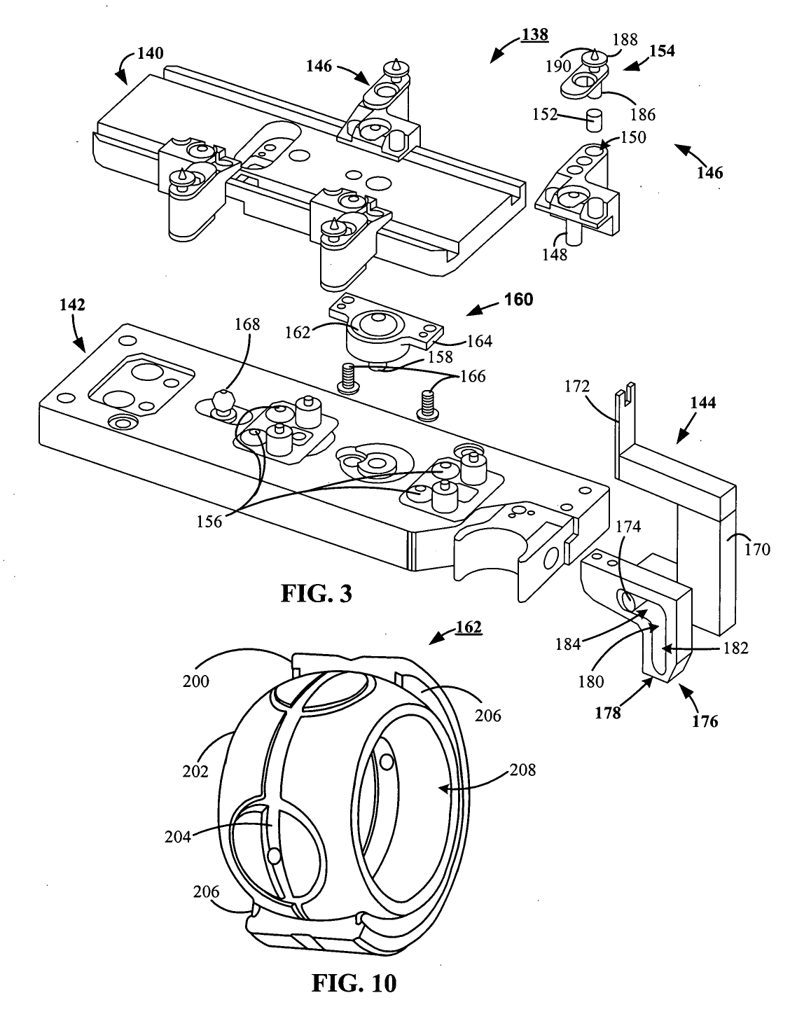

FIG. 3 shows a lift plate 138 embodiment of the present invention configured to interact with the base deck 102 (of FIG. 2). The lift plate 138 performs a lift operation, which raises the base deck 102 off the conveyor 130 (of FIG. 2) and transfers the base deck 102 into a precision placement for performance of assembly operations by a workstation of the DSD assembly line.

The lift plate 138 includes a lift deck 140, a backer plate 142, and a pair of mechanical fingers 144 (only one shown for clarity of presentation). The lift deck 140 supports a plurality of alignment members 146 (four shown), which are secured to the lift deck 140 by mounting hardware 148. Each alignment member 146 provides a containment cavity 150 for deposit of a visco-elastic damping material 152. The visco-elastic damping material 152 supports alignment posts 154 and dampens an impact of the alignment posts 154 engaging the base deck 102 during the lift operation.

The backer plate 142 is secured to a lift mechanism (not shown) by attachment hardware 156. Attached to the backer plate 142 by mounting hardware 158 is a centralized spherical bearing mechanism 160. The centralized spherical bearing mechanism 160 includes a gamble bearing 162, and a bearing support member 164. The bearing support member 164 provides mounting means for attachment of the lift deck 140 to the backer plate 142 through the use of attachment hardware 166. The backer plate 142 further provides means for attaching a spherical idler 168. The spherical idler 168 and the gamble bearing 162 supports the lift deck 140 and provides attitude adjustment for the lift deck 140 relative to the backer plate 142.

The mechanical finger 144 includes a backer block 170, which supports a positionable push plate 172 and a cam follower 174. The mechanical finger 144 further includes a cam 176 with a cam surface 178. The cam 176 is secured to the backer plate 142. During the lift process, the cam surface 178 determines and controls a rate and path of travel of the positionable push plate 172. The cam surface 178 includes a radius transition portion 180 interposed between a first travel control portion 182 and a second travel control portion 184.

During the lift process, the slope of the first travel control portion 182 controls the speed of travel of the positionable push plate 172 during a vertical displacement of the positionable push plate 172. The slope of the second travel control portion 184 controls an impact force imparted on the base deck 102 by the positionable push plate 172, when engagement between the positionable push plate 172 and the base deck 102 occurs during the lift process. As the lift mechanism begins its ascent, the vertical displacement of the positionable push plate 172 occurs at a rate faster than the rate of ascent of the lift mechanism.

Upon reaching a predetermined distance of travel for the lift mechanism, the cam follower 174 progresses through the radius transition portion 180 of the cam surface 178, and enters the second travel control portion 184 of the cam surface 178. When the cam follower 174 follows the slope of the second travel control portion 184, the rate of travel of the positionable push plate 172 is reduced to minimize mechanical shock imparted on the base deck 102 upon contact of the positionable push plate 172 with the base deck 102.

Each alignment post 154 includes a central shaft 186 supporting a land 188, and a positioning member 190 supported by the land 188. During the lift process, the positioning member 190 engages the mounting rail 128 (of FIG. 2) of the base deck 102. Upon engagement with the base deck 102 the positioning member 190 positions the base deck 102 relative to the central shaft 186 prior to engagement of the mounting rail 128 by the land 188.

During the lift process, the positioning member 190 of the alignment posts 154 aligns the base deck 102 in a first direction relative to the lift deck 140. That is, the positioning member 190 align the base deck 102 along a width of the base deck 102 relative to the lift deck 140. During the same lift process the positionable push plate 172, of the mechanical finger 144, positions the base deck 102 along a length of the base deck 102 relative to the lift deck 140, i.e., positions the base deck 102 in a second direction relative to the lift deck 140.

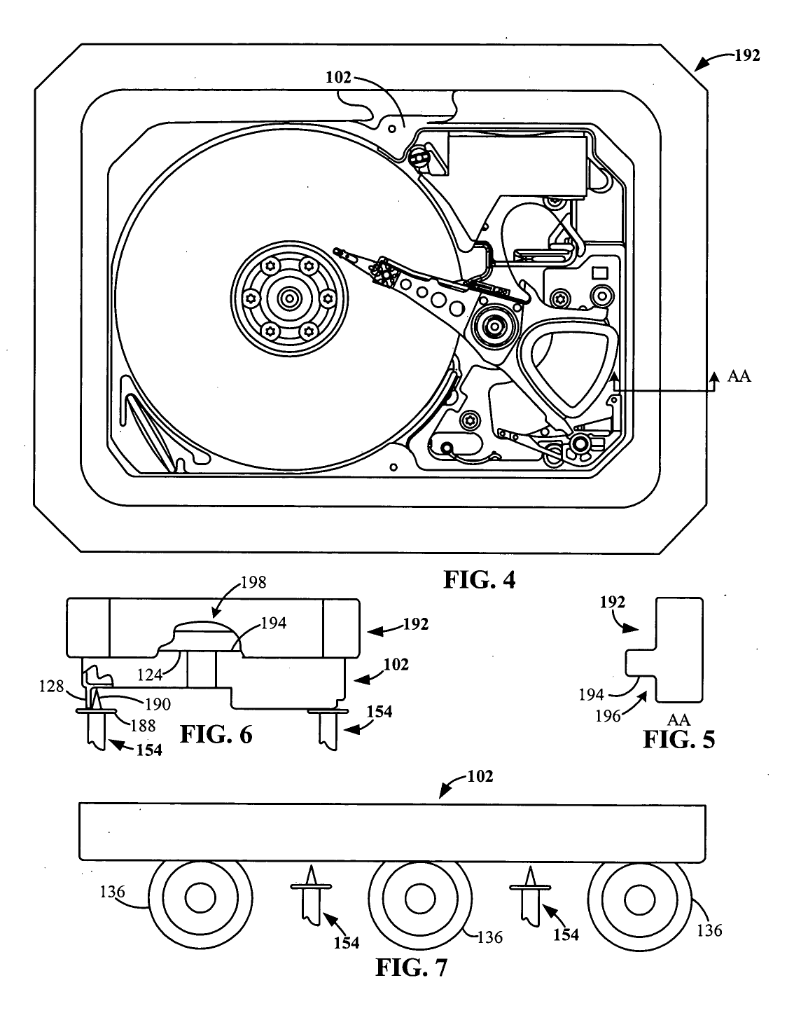

Because of the inability of the bottom surface 126 (of FIG. 2), and the mounting rail 128 to serve as references for precision placement of the base deck 102 into a workstation, the gambling capability of the lift deck 140 acts to accommodate interaction between the top surface 124 (of FIG. 2), a datum surface of the base deck 102, and a datum surface of an assembly nest 192, shown by FIG. 4. The gambling action of the lift deck 140 occurs after the alignment and positioning of the base deck 102 in the respective first and second directions. The adjustment of the datum surface of the base deck 102 to the datum surface of the assembly nest 192 commences with a first contact with the datum surface of the base deck 102, and concludes with attainment of a maximum vertical extent of the backer plate 142 during the lift process.

FIG. 4 shows the base deck 102 in aiding contact with the assembly nest 192, while FIG. 5 shows a cross-section “AA” of the assembly nest 192, which reveals a datum surface 194 and the base deck confinement channel 196. With the datum surface of the base deck 102 in substantial continuous contact with the datum surface 194 of the assembly nest 192, and the base deck 102 confined within the base deck confinement channel 196 precision positioning of the base deck 102 within the assembly nest 192 is achieved.

FIG. 6 shows the base deck 102 mated with the assembly nest 192, and through the cut-away portion 198, the interface between the datum surface 194 of the assembly nest 192, and the datum surface of the base deck 102 (top surface 124 of the base deck 102) can be seen. FIG. 6 also shows a final relationship between the mounting rail 128 and the alignment posts 154.

FIG. 7 shows the contact relationship between the base deck 102 and a plurality of idler wheels 136 of the conveyor 130 (of FIG. 2) prior to initiation of the lift process. FIG. 7 also shows the relationship of a pair of alignment posts 154 relative to the plurality of idler wheels 136 prior to commencement of the lift process.

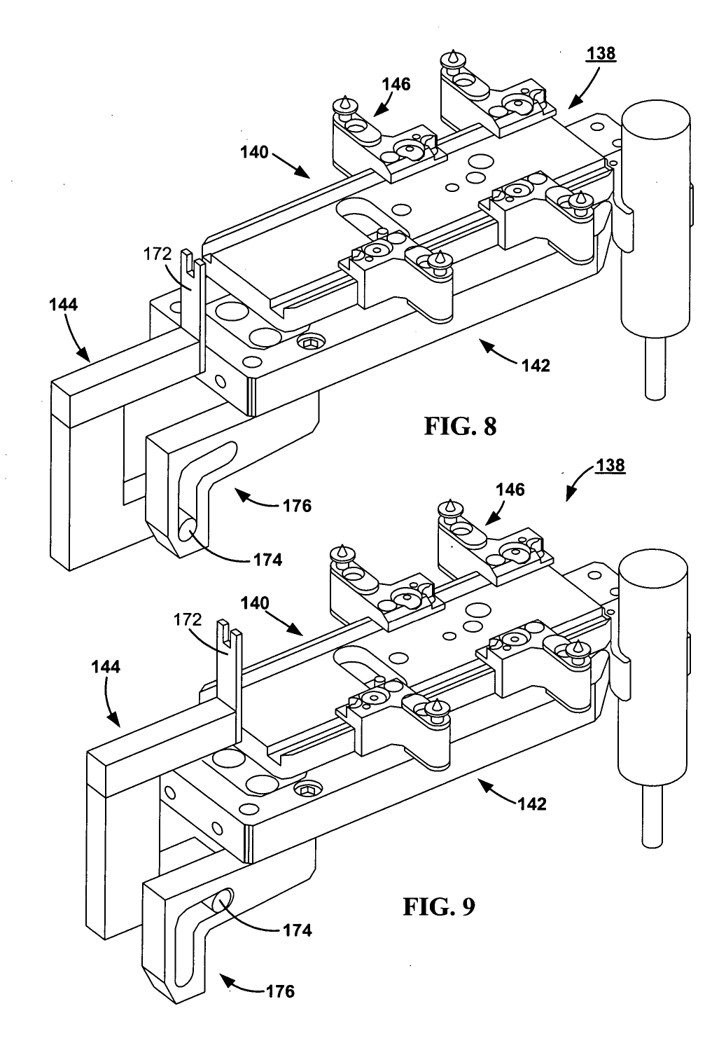

FIG. 8 shows the mechanical finger 144 attached to the backer plate 142 of the lift plate 138. As shown by the position of the cam follower 174 relative to the cam surface 178, the positionable push plate 172 is in a retracted position, which signifies the condition of the lift plate 138 prior to commencement of the lift process. FIG. 9 shows the condition of the lift plate 138 when, as shown by FIG. 5, the base deck 102 is precision positioned within the assembly nest 192 (of FIG. 4).

FIG. 10 shows the gamble bearing 162 which includes a race 200 confining a ball 202 having a lubricant channel 204, a seal 206, and a mounting aperture 208. The mounting aperture 208 provides access for the mounting hardware 158 (of FIG. 3), and the race 200 provides a mounting surface for the bearing support member 164 (of FIG. 3).

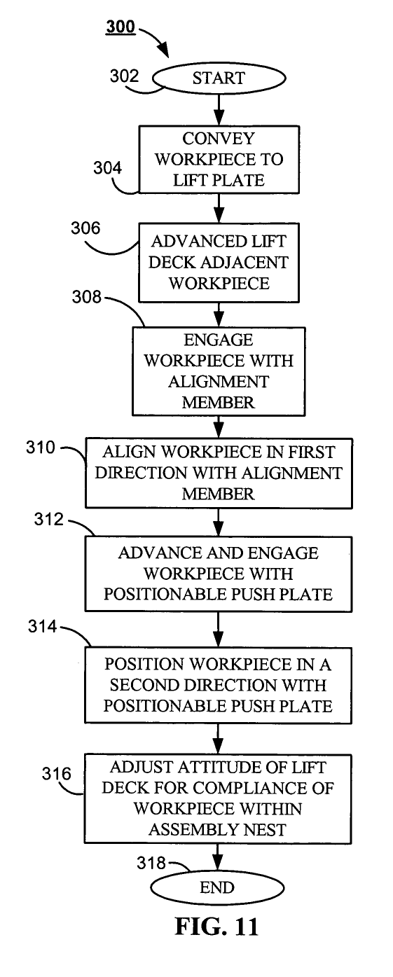

FIG. 11 shows a workpiece precision positioning process 300 commencing at start step 302 and continuing at process step 304 with conveyance of a workpiece (such as base deck 102) to a lift plate (such as 138) using a conveyor (such as 130). The process continues at process step 306 with the advancement of a lift deck (such as 140) of the lift plate into adjacency with the workpiece. At process step 308, the workpiece is engaged by an alignment post (such as 154) of an alignment member (such as 146), supported by the lift deck, and aligned in a first direction relative to the lift deck at process step 310.

At process step 312, the positionable push plate (such as 172) of a mechanical finger (such as 144), is advanced to and engages the workpiece. At process step 314, the workpiece is positioned in a second direction relative to the lift deck. With the workpiece positioned in both a first and second direction relative to the lift plate the process continues at process step 316. At process step 316, an attitude of the lift deck relative to a backer plate (such as 142) of the lift plate is adjusted through the use of a centralized spherical bearing mechanism (such as 160), which includes a gamble bearing (such as 162) and a bearing support member (such as 164). The attitude of the lift deck is adjusted to bring a datum surface of a top surface (such as 124) of the workpiece into compliance with a datum surface (such as 194) of an assembly nest (such as 192). The workpiece precise positioning process 300 concludes at end process step 318.

Use of a lift plate (such as 138) in conjunction with an assembly nest (such as 192) is illustrative of a preferred embodiment of the present invention which precludes exposure of a workpiece (such as 102) to excessive mechanical shock impacting the workpiece during alignment and positioning of the workpiece within the assembly nest to achieve precision positioning of the workpiece within the assembly nest.

It is to be understood that even though numerous characteristics and advantages of various embodiments of the present invention have been set forth in the foregoing description, together with details of the structure and function of various embodiments of the invention, this detailed description is illustrative only, and changes may be made in detail, especially in matters of structure and arrangements of parts within the principles of the present invention to the full extent indicated by the broad general meaning of the terms in which the appended claims are expressed.

What is claimed is:

1. An apparatus comprising:
a gimbal bearing mechanism which provides multi-directional compliance adjustment for a surface of a workpiece relative to a lift deck during an interaction of said workpiece with said lift deck; and
an alignment member attached to said lift deck comprising an alignment post supported by a visco-elastic damping material, said alignment post providing alignment of said workpiece in a first direction relative to said lift deck during said interaction.

2. The apparatus of claim 1, further comprising a mechanical finger adjacent said lift deck, said mechanical finger providing positioning of said workpiece in a second direction relative to said lift deck during said interaction of said workpiece with said lift deck.

3. The apparatus of claim 2, in which said workpiece is a base deck of a data storage device, and wherein said compliance adjustment is an adjustment of an attitude of a top surface of the base deck into compliance within a predetermined range.

4. The apparatus of claim 3, in which the top surface of said base deck is a base deck datum surface, and in which the predetermined range is established by an assembly nest datum surface of an assembly nest communicating with the base deck datum surface during said interaction of said workpiece with said lift deck.

5. The apparatus of claim 1, further comprising a backer plate supporting said gimbal bearing mechanism, wherein said gimbal bearing mechanism comprises a spherical bearing.

6. The apparatus of claim 2, in which the mechanical finger provides positioning of said workpiece in a second direction relative to said lift deck while the alignment post provides alignment of said workpiece in the first direction relative to said lift deck.

7. The apparatus of claim 6, in which the mechanical finger comprises:
a positionable push plate for contacting said workpiece;
a backer block supporting said positionable push plate providing stability to said positionable push plate through a path of travel of said positionable push plate during said interaction of said workpiece with said lift deck; and
a cam follower secured to the backer block, the cam follower follows a cam surface during said interaction of said workpiece with said lift deck, wherein the cam surface determines and controls the path of travel of said positionable push plate during said interaction of said workpiece with said lift deck.

8. The apparatus of claim 4, in which the mechanical finger provides positioning of the base deck in the second direction relative to said lift deck while the alignment post provides alignment of the base deck in the first direction relative to said lift deck, and wherein said lift deck adjusts the base deck datum surface into compliance with the assembly nest datum surface subsequent to alignment and positioning of the base deck in the first and second directions.

9. The apparatus of claim 7, in which the cam surface comprises a radiused transition portion interposed between the first and second travel control portions, wherein said first and second travel control portions regulate a time and distance for the cam follower to travel during respective first and second portions of said travel path.

10. The apparatus of claim 9, in which a slope of said first travel control portion controls a speed of travel of said positionable push plate during a vertical displacement of said positionable push plate, and in which a slope of said second travel control portion controls an impact force imparted to said workpiece by said positionable push plate when engagement between said positionable push plate and said workpiece occurs during said interaction of said workpiece with said lift deck.

11. The apparatus of claim 1, in which said workpiece is a base deck of a data storage device, the visco-elastic damping material mitigates a mechanical shock imparted on said base deck by said alignment post when engagement between said alignment post and said base deck occurs during said interaction of the base deck with said lift deck.

12. The apparatus of claim 11, in which the base deck comprised a mounting rail, and in which the alignment post comprises a central shaft supporting a land, and a positioning member supported by the land, wherein the positioning member engages the mounting rail to position the base deck relative to the central shaft prior to engagement of the mounting rail by the land during said interaction of the base deck with said lift deck.

13. A method comprising:
aligning a workpiece in a first direction relative to a lift plate using an alignment post supported by a visco-elastic damping material, said visco-elastic damping material supported by a lift deck of the lift plate;
positioning said workpiece in a second direction relative to said lift plate using a mechanical finger; and
adjusting attitude of said lift deck using a gimbal bearing mechanism communicating with said lift deck to bring a surface of said workpiece into compliance with an assembly nest datum of an assembly nest during an engagement of said workpiece with said assembly nest.

14. The method of claim 13, further comprising:
conveying said workpiece to said lift plate;
advancing said lift plate adjacent said workpiece; and
engaging said workpiece with a positioning member of said alignment post to position said workpiece in said second direction relative to said lift plate.

15. The method of claim 13, further comprising advancing a positionable push plate of said mechanical finger along a path of travel defined by a cam surface, and engaging said workpiece with said positionable push plate with a predetermined impact force controlled by a slope of said cam surface.

16. The method of claim 13, in which said mechanical finger positions said workpiece in said second direction while said alignment post aligns said workpiece in said first direction.

17. The method of claim 13, in which the surface of said workpiece is a top surface, and wherein adjustment of said attitude of said lift deck occurs subsequent to said alignment and positioning of said workpiece in respective said first and second directions.

18. The method of claim 17, in which said workpiece is a base deck of a data storage device, and wherein said top surface is a base deck datum surface of said base deck.

19. A method comprising:
aligning a workpiece in a first direction relative to a lift plate using an alignment post supported by a visco-elastic damping material, said visco-elastic damping material supported by a lift deck of the lift plate;
positioning said workpiece in a second direction relative to the lift plate using a mechanical finger; and
adjusting attitude of said lift deck to bring a datum surface of said workpiece into compliance with a datum surface of an assembly nest by means for bringing a datum surface of said workpiece into compliance with a datum surface of an assembly nest.

20. The method of claim 19, in which the means for bringing a datum surface of said workpiece into compliance with a datum surface of an assembly nest comprises a bearing mechanism supporting said lift deck, wherein said mechanism provides compliance adjustment of an attitude of the datum surface of the base deck with the attitude of the datum surface of the assembly nest by promoting gimbaling of said lift deck about a gimbal bearing of said mechanism.
